(19) United States
(12) Patent Application Publication
(10) Pub. No.: US 2025/0270772 A1
(43) Pub. Date: Aug. 28, 2025

(54) VIBRATOR FREQUENCIES FOR SLIPFORM PAVERS

(71) Applicant: GOMACO Corporation, Ida Grove, IA (US)

(72) Inventors: Mark W. Brenner, Ida Grove, IA (US); Thomas C. Farr, Ida Grove, IA (US)

(21) Appl. No.: 19/048,274

(22) Filed: Feb. 7, 2025

Related U.S. Application Data
(60) Provisional application No. 63/557,176, filed on Feb. 23, 2024.

(51) Int. Cl. E01C 19/48; B06B 1/18; E01C 23/01; H02K 7/06

(52) U.S. Cl. CPC E01C 19/4893; B06B 1/186; E01C 23/01; H02K 7/061; B06B 2201/70; E01C 2301/04

(57) ABSTRACT

Slipform paver may include rheometers for measuring rheological parameters. The rheometers may include vane rheometers in a grout box of the slipform mold. The slipform paver may dynamically determining the rheological parameters of concrete and controlling a target vibrational frequency of vibrators based on the rheological parameters. The slipform paver may also use depth sensors, cameras, and/or electric vibrators for controlling the target vibration frequency.

### CROSS-REFERENCE TO RELATED APPLICATIONS

The present application claims the benefit under 35 U.S.C. § 119(e) of U.S. Provisional Application Ser. No. 63/557,176, filed on Feb. 23, 2024, titled “VIBRATOR FREQUENCIES FOR SLIPFORM PAVERS”, which is incorporated herein by reference in the entirety.

### TECHNICAL FIELD

Embodiments of the invention are directed generally toward machines forming and consolidating paving materials, and more particularly to consolidating by vibration.

### BACKGROUND OF THE INVENTION

Slipform pavers use molds with vibrators to consolidate concrete into a slab. Paver operators set the frequency of the vibrators to achieve a desired texture and strength. Setting the frequency too high or too low may cause vibrator trails or strength defects, respectively, in the slab. Therefore, it would be advantageous to provide a device, system, and method that cures the shortcomings described above.

### SUMMARY

In some aspects, the techniques described herein relate to a paving machine including: a slipform mold, the slipform mold configured to form concrete into a slab; the slipform mold including: a plurality of hydraulic vibrators; wherein the plurality of hydraulic vibrators are configured to vibrate in response to receiving hydraulic fluid; the plurality of hydraulic vibrators including a plurality of vibration sensors configured to measure actual vibrations of the plurality of hydraulic vibrators; a finishing pan; a pair of side plates; and one or more rheometers; wherein the one or more rheometers are configured to measure one or more rheological parameters of the concrete; a hydraulic power supply including a hydraulic pump; a hydraulic manifold; wherein the hydraulic manifold is coupled between the hydraulic pump and the plurality of hydraulic vibrators; and a controller including one or more processors configured, via executable code, to: cause the hydraulic manifold to control an actual flow rate of the hydraulic fluid from the hydraulic pump to the plurality of hydraulic vibrators towards target frequencies using the actual frequencies as feedback; and dynamically update the target frequencies based on the one or more rheological parameters.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the description and drawings serve to explain the principles of the disclosure.

### BRIEF DESCRIPTION OF THE DRAWINGS

The numerous advantages of the disclosure may be better understood by those skilled in the art by reference to the accompanying figures in which:

FIGS. 1A-1B depicts a front perspective view of a paving machine, in accordance with one or more embodiments of the present disclosure.

FIG. 1C depicts a side view of a slipform mold including a rheometer, in accordance with one or more embodiments of the present disclosure.

FIG. 1D depicts a front view of a paving machine, in accordance with one or more embodiments of the present disclosure.

FIG. 1E depicts a front perspective view of a slipform mold, in accordance with one or more embodiments of the present disclosure.

FIG. 1F depicts a side view of a slipform mold including a rheometer, in accordance with one or more embodiments of the present disclosure.

FIG. 1G depicts a simplified circuit diagram of a paving machine using rheological parameters from a rheometer to dynamically update target frequencies of hydraulic vibrators, in accordance with one or more embodiments of the present disclosure.

FIG. 2A depicts a front perspective view of a paving machine with depth sensors, in accordance with one or more embodiments of the present disclosure.

FIG. 2B depicts a simplified circuit diagram of a paving machine using depth maps from depth sensors to dynamically update target frequencies of hydraulic vibrators, in accordance with one or more embodiments of the present disclosure.

FIG. 3A depicts a side view of a paving machine including cameras, in accordance with one or more embodiments of the present disclosure.

FIG. 3B depicts a rear perspective view of a paving machine including cameras, in accordance with one or more embodiments of the present disclosure.

FIG. 3C depicts a simplified circuit diagram of a paving machine using images from cameras to dynamically update target frequencies of hydraulic vibrators, in accordance with one or more embodiments of the present disclosure.

FIG. 3D depicts an example image with surface voids which are relatively large, in accordance with one or more embodiments of the present disclosure.

FIG. 3E depicts an example image with surface voids which are relatively small, in accordance with one or more embodiments of the present disclosure.

FIG. 4A depicts a front perspective view of a paving machine with electric vibrators, in accordance with one or more embodiments of the present disclosure.

FIG. 4B depicts a simplified circuit diagram of a paving machine with electric vibrators, in accordance with one or more embodiments of the present disclosure.

FIG. 5A depicts a front perspective view of a paving machine with an electric vibrator which acts as a sensor in a bank of hydraulic vibrators, in accordance with one or more embodiments of the present disclosure.

FIG. 5B depicts a simplified circuit diagram of a paving machine with an electric vibrator which acts as a sensor in a bank of hydraulic vibrators, in accordance with one or more embodiments of the present disclosure.

FIGS. 6A-6B depict a top view of a system including a paving machine and a mixer truck, in accordance with one or more embodiments of the present disclosure.

FIG. 6C depicts a simplified circuit diagram of a paving machine with meteorological sensors which are used to update rheological parameters received from the mixer truck due to water evaporation over time, in accordance with one or more embodiments of the present disclosure.

FIG. 6D depicts an example graph of a computation performed by a controller when updating the rheological parameter over time using the meteorological data for compensation where the rheological parameter is slump and the meteorological data is temperature, in accordance with one or more embodiments of the present disclosure.

FIG. 7 depicts a front perspective view of the paving machine configured as a two-track machine, in accordance with one or more embodiments of the present disclosure.

FIG. 8A depicts a rear perspective view of a paving machine configured as a curb-and-gutter paving machine, in accordance with one or more embodiments of the present disclosure.

FIG. 8B depicts a front perspective view of a paving machine configured as a barrier paving machine, in accordance with one or more embodiments of the present disclosure.

FIG. 8C depicts a partial perspective view inside a hopper of an offset slipform mold of the paving machine, in accordance with one or more embodiments of the present disclosure.

### DETAILED DESCRIPTION OF THE INVENTION

Before explaining one or more embodiments of the disclosure in detail, it is to be understood that the embodiments are not limited in their application to the details of construction and the arrangement of the components or steps or methodologies set forth in the following description or illustrated in the drawings. In the following detailed description of embodiments, numerous specific details may be set forth in order to provide a more thorough understanding of the disclosure. However, it will be apparent to one of ordinary skill in the art having the benefit of the instant disclosure that the embodiments disclosed herein may be practiced without some of these specific details. In other instances, well-known features may not be described in detail to avoid unnecessarily complicating the instant disclosure.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only and should not be construed to limit the disclosure in any way unless expressly stated to the contrary.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” may be employed to describe elements and components of embodiments disclosed herein. This is done merely for convenience and “a” and “an” are intended to include “one” or “at least one,” and the singular also includes the plural unless it is obvious that it is meant otherwise.

Finally, as used herein any reference to “one embodiment”, “in embodiments”, or “some embodiments” means that a particular element, feature, structure, or characteristic described in connection with the embodiment is included in at least one embodiment disclosed herein. The appearances of the phrase “in some embodiments” in various places in the specification are not necessarily all referring to the same embodiment, and embodiments may include one or more of the features expressly described or inherently present herein, or any combination or sub-combination of two or more such features, along with any other features which may not necessarily be expressly described or inherently present in the instant disclosure.

Reference will now be made in detail to the subject matter disclosed, which is illustrated in the accompanying drawings. Embodiments of the present disclosure are directed to vibrator frequencies for slipform pavers. Slipform paver may include rheometers for measuring rheological parameters. The rheometers may include vane rheometers in a grout box of the slipform mold. The slipform paver may dynamically determining the rheological parameters of concrete and controlling a target vibrational frequency of vibrators based on the rheological parameters. The slipform paver may also use depth sensors, cameras, and/or electric vibrators for controlling the target vibration frequency.

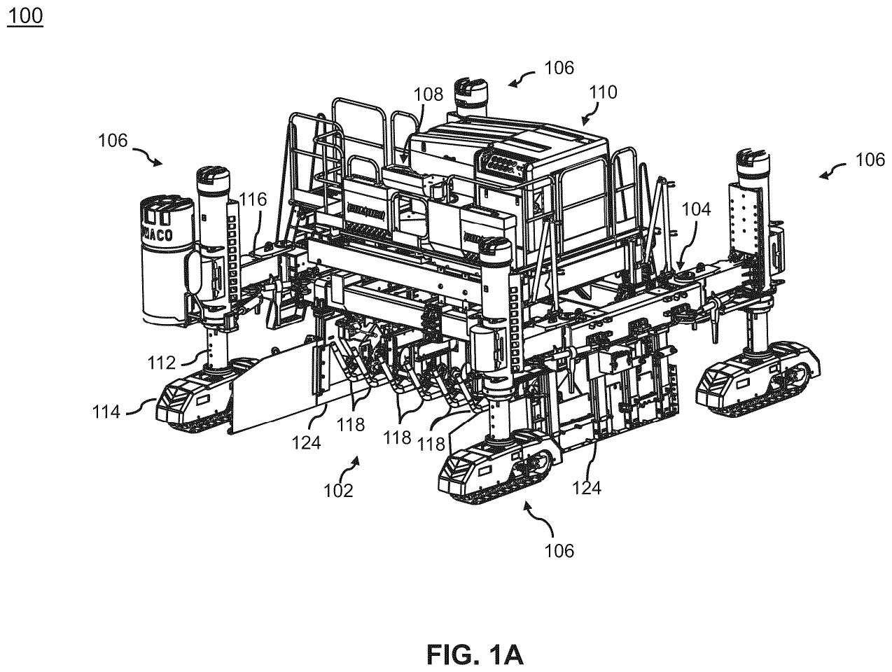

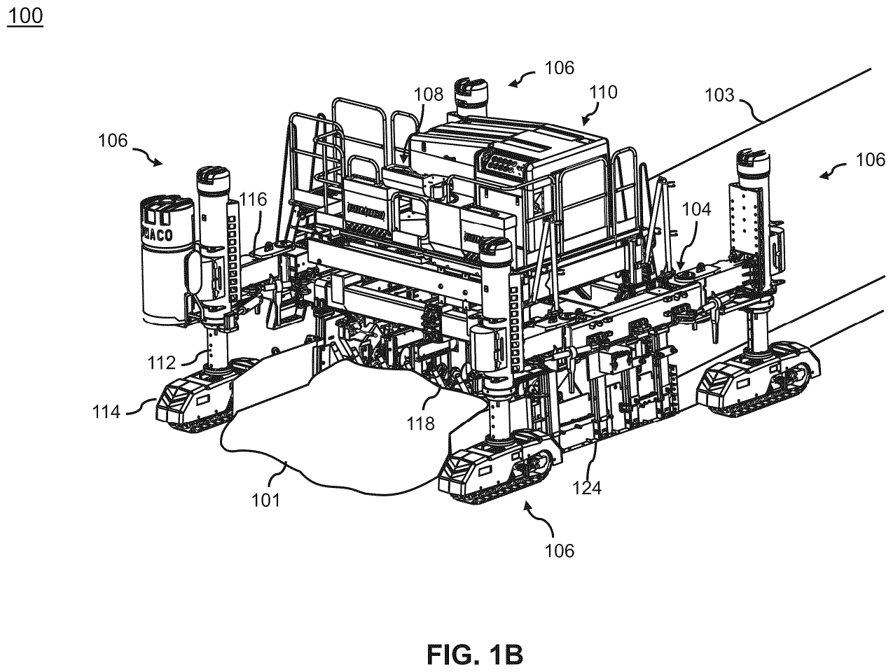

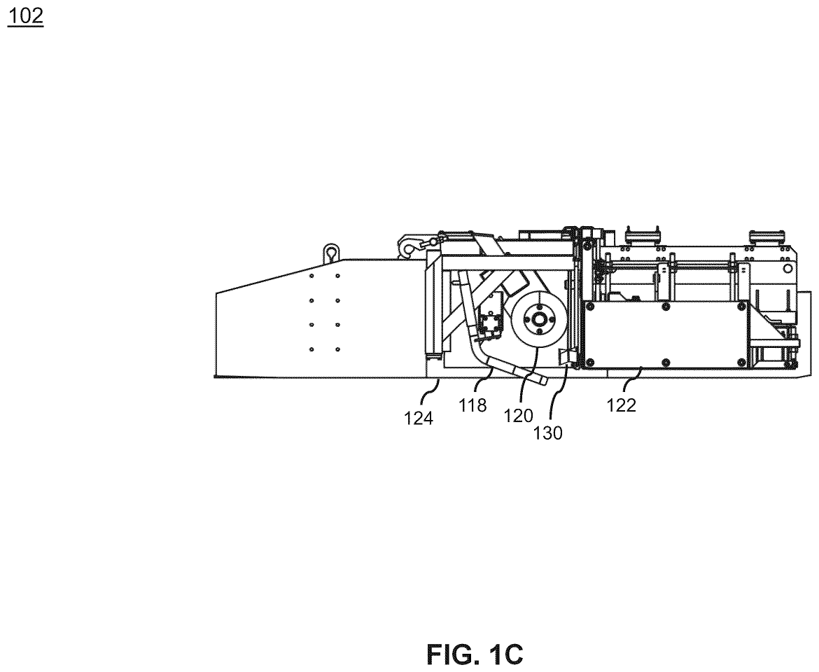

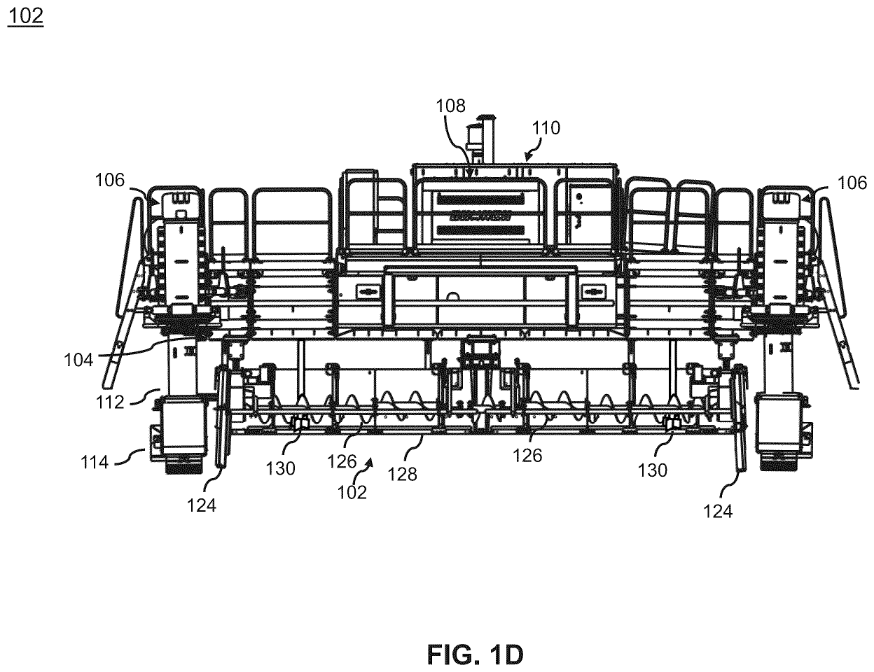

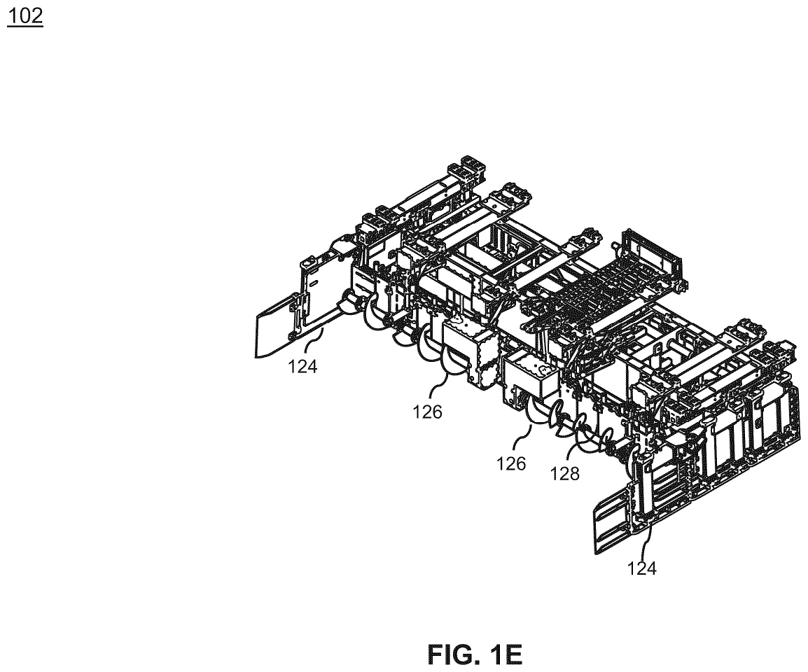

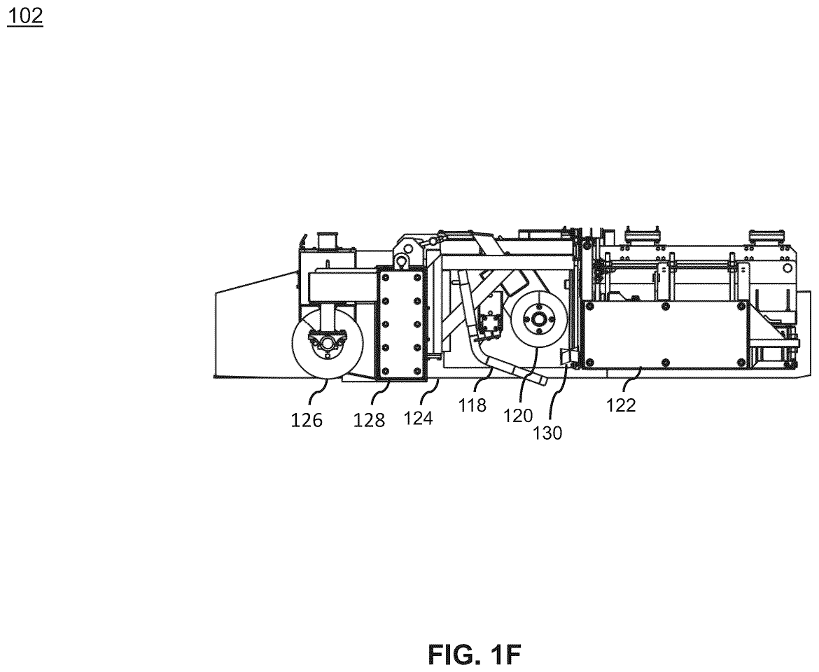

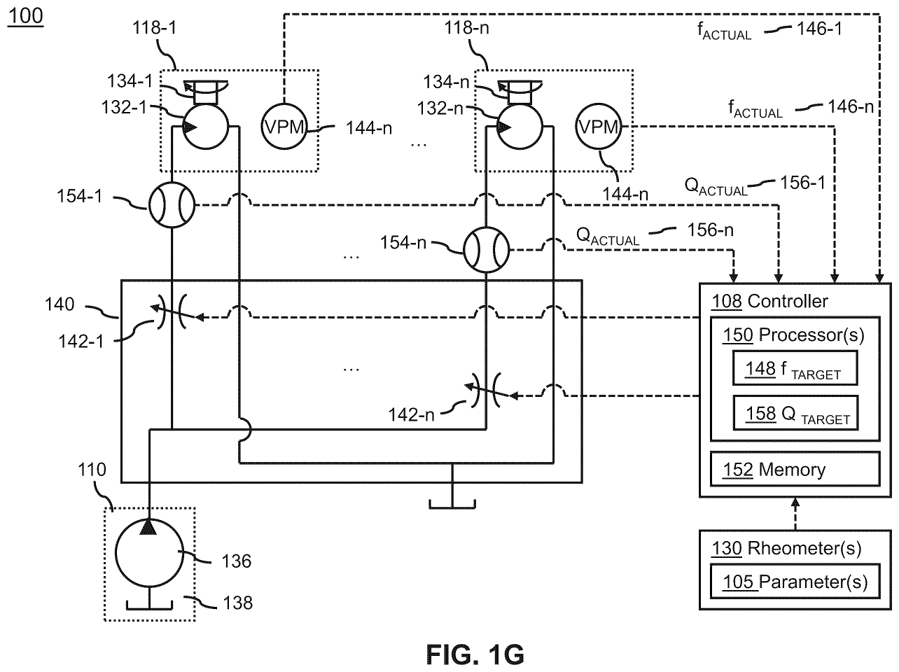

Referring generally to FIGS. 1A-1G, a paving machine 100 is described, in accordance with one or more embodiments of the present disclosure. The paving machine 100, may be any suitable paving machine, such as, but not limited to, a slipform paver. The paving machine 100 may include one or more components, such as, but not limited to, a slipform mold 102, frame 104, end structures 106, controller 108, hydraulic power supply 110, pivot arms 116, and the like.

The paving machine 100 may include the slipform mold 102. The slipform mold 102 may be coupled to the frame 104. The slipform mold 102 may be an inset mold and mounted below the frame 104. The slipform mold 102 may be moved in a paving direction for forming concrete 101 into a slab 103. The concrete 101 may be poured ahead of the slipform mold 102. For example, the concrete 101 may be poured ahead of the slipform mold 102 by a placer/spreader machine or the like. The slipform mold 102 may consolidate the concrete 101 to form the slab 103. Thus, the slipform mold 102 may perform slipform paving operations.

The slipform mold 102 may include one or more components, such as, but not limited to, hydraulic vibrators 118, grout box auger 120, tamper bar (not depicted), finishing pan 122, side plates 124, split front auger 126, strike-off 128, rheometers 130, and the like.

The slipform mold 102 may include grout box auger 120. The grout box auger 120 may also be referred to as a spreader/auger. The grout box auger 120 may span between the pair of the side plates 124. The grout box auger 120 may be disposed behind and/or above the hydraulic vibrators 118 in the paving direction. The grout box auger 120 may be longitudinally disposed between the hydraulic vibrators 118 and the finishing pan 122. The grout box auger 120 may spread the concrete 101 across a lateral width of the slipform mold 102 (i.e., perpendicular to the paving direction). The grout box auger 120 may include any suitable screw conveyor design for spreading the concrete 101 across the lateral width. For example, the grout box auger 120 may include a range of suitable pitches, flights, and diameters for spreading the concrete 101. The grout box auger 120 may be further coupled with a motor, for rotating the grout box auger 120. A rotational speed of the grout box auger 120 may be adjusted. The rotational speed of the grout box auger 120 may be adjusted based on a speed of the paving machine 100, the rheological parameters 105, and the like.

The slipform mold 102 may include finishing pan 122. The finishing pan 122 may span between the side plates 124. The finishing pan 122 may be configured to finish the concrete 101 into the slab 103. For example, the finishing pan 122 may form the top surface of the slab 103.

The slipform mold 102 may include side plates 124. The side plates 124 may also be referred to as side forms, or the like. The volume between the side plates 124 may be referred to as a grout box. The concrete 101 may be maintained between the side plates 124 as the paving machine 100 travels in the paving direction. The side plates 124 may form the sides of the slab 103 from the concrete 101.

The slipform mold 102 may include the split front auger 126 and/or the strike-off 128. The split front auger 126 may be disposed in front of the strike-off 128 in the paving direction. The split front auger 126 may spread the concrete 101 across a lateral width of the slipform mold 102 (i.e., perpendicular to the paving direction). The split front auger 126 may be split into left-hand and right-hand sections. The left-hand and right-hand sections of the split front auger 126 may be independently driven. The strike-off 128 may span between the side plates 124. The strike-off 128 may be longitudinally disposed between the split front auger 126 and the hydraulic vibrators 118. The strike-off 128 may include a flat plate which may strike off the concrete 101 at a select height. Although the slipform mold 102 is described as including the split front auger 126 and the strike-off 128, this is not intended as a limitation of the present disclosure. The slipform mold 102 may include an open front configuration which may not include the split front auger 126 and the strike-off 128.

The slipform mold 102 may include hydraulic vibrators 118. The hydraulic vibrators 118 may vibrate the concrete 101 for consolidating air out of the concrete 101. The hydraulic vibrators 118 may be laterally disposed between the side plates 124. The paving machine 100 may include any number of the hydraulic vibrators 118-1 through 118-n, where n is an integer. For example, n may include but is not limited to two vibrators, four vibrators, six vibrators, eight vibrators, sixteen vibrators, thirty-two vibrators, or more. The hydraulic vibrators 118 may include any type of vibrator, such as, but not limited to, immersion vibrators (also known as needle vibrators, bent pipe vibrator, internal vibrators), external vibrators (also known as shutter vibrator or formwork vibrator), or surface vibrators (also known as pan vibrators). In embodiments, the hydraulic vibrators 118 are immersion vibrators. For example, the hydraulic vibrators 118 may vibrators described in U.S. Pat. No. 6,055,486, titled ACCELEROMETER-BASED MONITORING AND CONTROL OF CONCRETE CONSOLIDATION, which is incorporated herein by reference in the entirety.

The paving machine 100 may include the hydraulic power supply 110. The hydraulic power supply 110 may be connected to the frame 104. The hydraulic power supply 110 may include several components, such as, but not limited to, power sources, hydraulic pumps 136, hydraulic reservoirs 138, filters, coolers, heaters, and the like. The power sources may include any power source configured to generate power known in the art, such as, but not limited to, a gasoline engine, a diesel engine, or an electric power source of various sizes and power ratings. The power sources may power the hydraulic pumps 136. The hydraulic pump 136 may receive a mechanical drive or electrical power from the power source and generates a flow of hydraulic fluid with hydraulic power. The hydraulic reservoir 138 may also referred to as a hydraulic fluid reservoir. The hydraulic pumps 136 may be connected to the hydraulic reservoir 138 and configured to supply a flow of hydraulic fluid from the hydraulic reservoir 138. The hydraulic pumps 136 may be configured to pump hydraulic fluid from the hydraulic reservoir 138 and supply a flow (e.g., hydraulic power) of the hydraulic fluid to one or more hydraulic components of the paving machine 100.

The hydraulic vibrators 118 may include a hydraulic motor 132, an eccentric weight 134, and the like. The hydraulic motor 132 may be fluidically coupled to the hydraulic pumps 136. The hydraulic pumps 136 may supply a flow of hydraulic fluid to the hydraulic motor 132. The hydraulic motor 132 may cause the eccentric weight 134 to vibrate in response to receiving the flow of hydraulic fluid. The hydraulic motor 132 may receive actual flow rates 156 (Q_{ACTUAL}) of the hydraulic fluid. The hydraulic motor 132 may vibrate the eccentric weight 134 at actual frequencies 146 (f_{ACTUAL}) in response to receiving the actual flow rates 156. The actual frequencies 146 may be proportional to the actual flow rates 156. Increases in the actual flow rates 156 of hydraulic fluid will, in turn, create an increase in the actual frequencies 146. For example, the actual frequencies 146 may scale (e.g., linearly scale) with the actual flow rates 156. Each of the hydraulic vibrators 118-1 through 118-n may include a respective of the hydraulic motors 132-1 through 132-n, the eccentric weights 134-1 through 134-n, and the like. Similarly, each of the hydraulic vibrators 118-1 through 118-n may receive a respective of the actual flow rates 156-1 through 156-n and may vibrate at respective of the actual frequencies 146-1 through 146-n.

The paving machine 100 may include a hydraulic manifold 140. The hydraulic manifold 140 may be coupled between the hydraulic pump 136 and the hydraulic vibrators 118. The hydraulic manifold 140 may control the actual flow rates 156 of hydraulic fluid to the hydraulic vibrators 118. For example, the hydraulic manifold 140 may be configured to control the actual flow rates 156 of the hydraulic fluid to hydraulic motors 132. In embodiments, the hydraulic manifold 140 may include adjustable flow control valves 142. The hydraulic manifold 140 may include adjustable flow control valves 142-1 through 142-n for each of the respective of the hydraulic vibrators 118-1 through 118-n. The adjustable flow control valves 142 may control the actual flow rates 156 of hydraulic fluid from the hydraulic pump 136 to the hydraulic vibrators 118. The adjustable flow control valves 142 may receive electrical signals from the controller 108, causing the hydraulic manifold 140 to control the actual flow rates 156 to each of the hydraulic motors 132. The actual frequencies 146 at which the hydraulic vibrators 118 vibrate may be based on the actual flow rates 156 of hydraulic fluid. Thus, the actual flow rates 156 of hydraulic fluid may be controlled to control the actual frequencies 146 of the hydraulic vibrators 118. The hydraulic vibrators 118 may include a range of the actual frequencies 146 between which the hydraulic vibrators 118 may be controlled. For example, the actual frequencies 146 of the hydraulic vibrators 118 may be selectively controllable between zero and ten-thousand vibrations per minute (VPMs), or more. The actual frequencies 146 of the hydraulic vibrators 118 may be controlled by varying the actual flow rates 156 of hydraulic fluid to the hydraulic vibrators 118. For example, the adjustable flow control valves 142-1 through 142-n may control the actual frequencies 146-1 through 146-n of the hydraulic vibrators 118-1 through 118-n by varying the actual flow rates 156-1 through 156-n of hydraulic fluid.

The paving machine 100 may include the controller 108. The controller 108 may be configured to control the hydraulic manifold 140. For example, the controller 108 may control the adjustable flow control valves 142 of the hydraulic manifold 140. The controller 108 may control the adjustable flow control valves 142 using one or more electrical signals, for selectively controlling the actual flow rates 156 of the hydraulic fluid to the hydraulic motors 132, thereby controlling the actual frequencies 146 of the hydraulic vibrators 118. The controller 108 may independently control the adjustable flow control valves 142, such that the actual frequencies 146 of the hydraulic vibrators 118 may be independently controlled.

In embodiments, the hydraulic vibrators 118 may include vibration sensors 144. The vibration sensors 144 may include, but are not limited to, accelerometers or the like. The vibration sensors 144 may be configured to measure actual frequencies 146 (f_{ACTUAL}) of the hydraulic vibrators 118.

In embodiments, the paving machine 100 may include flow meters 154. The flow meters 154 may be coupled between the hydraulic manifold 140 and the hydraulic vibrators 118. The flow meters 154 may measure the actual flow rates 156. For example, the flow meters 154 may include flow meters 154-1 through 154-n coupled between respective of the adjustable flow control valves 142-1 through 142-n and the hydraulic vibrators 118-1 through 118-n. The flow meters 154-1 through 154-n may measure the actual flow rates 156-1 through 156-n. The controller 108 may receive the actual flow rates 156 from the flow meters 154 and/or the actual frequencies 146 of the hydraulic vibrators 118 from the vibration sensors 144 (e.g., vibration sensors 144-1 through 144-n)

The controller 108 may use the actual flow rates 156 and/or the actual frequencies 146 as feedback when causing the hydraulic manifold 140 to control the actual flow rates 156 of the hydraulic fluid from the hydraulic pump 136 to the hydraulic vibrators 118 thereby controlling the actual frequencies 146 of the hydraulic vibrators 118. The controller 108 may use the actual flow rates 156 and/or the actual frequencies 146 as feedback when adjusting the actual flow rates 156 of hydraulic fluid to the hydraulic vibrators 118, thereby moving the actual flow rates 156 towards the target flow rates 158. Similarly, the controller 108 may use the actual flow rates 156 and/or the actual frequencies 146 as feedback when adjusting the actual flow rates 156 of hydraulic fluid to the hydraulic vibrators 118, thereby moving the actual frequencies 146 towards the target frequencies 148. Either of the actual flow rates 156 and/or the actual frequencies 146 may be used as feedback. The actual flow rates 156 may be easier or more accurate to measure and may provide an indicate of the actual frequencies 146.

The target flow rates 158 and/or target frequencies 148 may be preset. The target flow rates 158 and/or target frequencies 148 may be preset in the memory. The controller 108 may include one or more user interfaces (not depicted). The user interfaces may set the target flow rates 158 and/or target frequencies 148. For example, the controller 108 may include dials, switches, touchscreen controls, or the like for setting the target flow rates 158 and/or target frequencies 148. A paver operator may input the target flow rates 158 and/or target frequencies 148 using the user interfaces. In this regard, the target flow rates 158 and/or target frequencies 148 may be preset by the human operator.

The hydraulic vibrators 118 may consolidate the concrete 101. The hydraulic vibrators 118 may vibrate at the actual frequencies 146 to consolidate the concrete 101. Consolidating the concrete 101 may remove voids in and/or reduce an air content of the concrete 101. The actual frequencies 146 of the hydraulic vibrators 118 may control a texture and/or strength of the slab 103. For example, the consolidation may be proportional to the actual frequencies 146. Vibrating the concrete 101 at an excessive frequency may cause too much air to escape, thereby causing vibrator trails. Vibrating the concrete 101 at an insufficient frequency may cause too much air to be entrained, thereby reducing a strength of the slab 103.

The hydraulic vibrators 118 may be maintained at actual frequencies 146 between the insufficient frequency and the excessive frequency to achieve the desired texture and/or strength. The insufficient frequency may occur when the hydraulic vibrators 118 receive an insufficient flow rate of the hydraulic fluid. The controller 108 may cause the hydraulic manifold 140 to control the actual flow rates 156 to the hydraulic vibrators 118 towards target frequencies 148 using the actual frequencies 146 as feedback. Similarly, the excessive frequency may occur when the hydraulic vibrators 118 receive an excessive flow rate of the hydraulic fluid. The actual flow rates 156 may be maintained between the insufficient flow rate and the excessive flow rate to maintain the actual frequencies 146 between the insufficient frequency and the excessive frequency. The controller 108 may cause the hydraulic manifold 140 to control the actual flow rates 156 to the hydraulic vibrators 118 towards the target flow rates 158 using the actual flow rates 156 as feedback.

The concrete 101 may include a composition of cements, water, aggregates (e.g., sand, coarse aggregates), admixtures (e.g., plasticizers, accelerators, retarders, air entrainers, corrosion inhibitors), and the like. The composition of the concrete 101 may be based on a mix design and may vary between batches, mixer trucks, and concrete plants, such that the specific composition of the concrete is not intended to be limiting. The concrete 101 may include rheological parameters 105. The composition of the concrete 101 may control the rheological parameters 105. The rheological parameters 105 may include, but are not limited to, workability, yield stress (τ₀), plastic viscosity (μ), slump, and the like. The workability may be the ease with which the concrete 101 may be mixed, placed, consolidated, and finished to a homogenous condition. The yield stress may be the minimum stress to initiate or maintain flow. The plastic viscosity may be the resistance to flow once the yield stress is exceeded. The plastic viscosity (μ) may be determined based on shear stress (τ), the yield stress (τ₀), and a shear rate (γ) according to the Bingham model (i.e., τ=+μ*γ). The shear stress (τ) may be the component of force across a cross section of the concrete. The shear rate (γ) the rate of shearing deformation. The slump may refer to the measure of consistency of the concrete 101 equal to the subsidence after removal from a slump cone. The slump may be related to the yield stress and the plastic viscosity. For example, higher yield stresses and higher plastic viscosities may correspond to lower slumps. Concrete with a higher slump may more easily flow than concrete with a lower slump.

The rheological parameters 105 of the concrete 101 may impact the insufficient frequency and the excessive frequency at which the concrete 101 is vibrated, and similarly the insufficient flow rate and the excessive flow rate of hydraulic fluid to the hydraulic vibrators 118. The rheological parameters 105 of the concrete 101 may be dynamic and change as the paving machine 100 paves the concrete 101. For example, the rheological parameters 105 may change due to slump loss (e.g., due to a reduction in water content over time, false setting, etc.). By way of another example, the concrete may not be homogenous along the length of the pour. By way of another example, mixer trucks may source the concrete with different compositions (e.g., from different batch plants). By way of another example, a depth of the concrete may change the rheological parameters 105. The dynamic nature of the concrete 101 may cause the insufficient frequency and the excessive frequency to change over time, such that fixing the actual frequencies 146 of the hydraulic vibrators 118 and/or the actual flow rates 156 to the hydraulic vibrators 118 at set values may cause spots in the slab 103 with vibrator trails due to over-consolidation and/or spots in the slab 103 which are weakened due to under-consolidation.

The slipform mold 102 may include rheometers 130. For example, the rheometers 130 may be laterally disposed between the side plates 124 (e.g., within the grout box). The rheometers 130 may be below and/or behind the grout box auger 120 in the paving direction. The rheometers 130 may be above and/or in front of the finishing pan 122 in the paving direction. For example, the rheometers 130 may be disposed above a bottom surface of the finishing pan 122 such that the rheometers 130 are disposed above the top surface of the slab 103. Thus, the rheometers 130 may be longitudinally disposed between the hydraulic vibrators 118 and the finishing pan 122 and/or between the grout box auger 120 and the finishing pan 122. The rheometers 130 may be secured in a fixed position relative to the side plates 124. For example, the rheometers 130 may be secured with a minimum distance to the side plates 124. The minimum distance may be based on a size of the aggregates in the concrete 101.

The rheometers 130 may include, but are not limited to, vane rheometers, slump sensors, viscometers (e.g., an in-line viscometer, quartz viscometer, and the like), strain gauges, and the like. In embodiments, the rheometers 130 are vane rheometers. For example, the rheometers 130 may include one or more vanes which are rotated at one or more speeds. The rheometers 130 may measure a torque induced on the vanes by the concrete 101 when the vanes are rotated at the one or more speeds.

The rheometers 130 may measure the rheological parameters 105 of the concrete 101. The rheometers 130 may continually measure the rheological parameters 105 of the concrete 101 as the paving machine 100 paves the concrete 101.

The controller 108 may receive the rheological parameters 105 of the concrete 101 from the rheometers 130. The controller 108 may control the actual flow rates 156 of hydraulic fluid to the hydraulic vibrators 118 and/or the actual frequencies 146 of the hydraulic vibrators 118 based on the rheological parameters 105. For example, the controller 108 may dynamically update the target flow rates 158 and/or the target frequencies 148 based on the rheological parameters 105. Where the rheological parameters 105 indicate the concrete 101 is easily workable, the target flow rates 158 and/or the target frequencies 148 may be decreased. Where the rheological parameters 105 indicate the concrete 101 is hard to work, the target flow rates 158 and/or the target frequencies 148 may be increased.

The actual flow rates 156 to the hydraulic vibrators 118 may be continually updated towards the target flow rates 158 and/or the actual frequencies 146 may be continually updated towards the target frequencies 148 based on the actual flow rates 156 measured by the flow meters 154 and/or the actual frequencies 146 measured by the vibration sensors 144 when the target flow rates 158 and/or the target frequencies 148 are dynamically updated based on the rheological parameters 105. For example, the actual flow rates 156 to the hydraulic vibrators 118 may be continually updated towards the target flow rates 158 based on the actual flow rates 156 measured by the flow meters 154 when the target flow rates 158 are dynamically updated based on the rheological parameters 105. By way of another example, the actual frequencies 146 may be continually updated towards the target frequencies 148 based on the actual frequencies 146 measured by the vibration sensors 144 when the target frequencies 148 are dynamically updated based on the rheological parameters 105. Updating the actual flow rates 156 to the hydraulic vibrators 118 towards the target flow rates 158 and/or the actual frequencies 146 towards the target frequencies 148 may enable controlling the actual frequencies 146 of the hydraulic vibrators 118 based on the rheological parameters 105.

The controller 108 may include processors 150 and memory 152. The processors 150 may be configured to execute a set of executable code maintained on the memory 152. The set of executable code may be configured to cause the processors 150 to carry out the functions of the controller 108.

The target frequencies 148 and/or the target flow rates 158 for the rheological parameters 105 may be stored in the memory 152 as a lookup table or similar pre-stored information. The controller 108 may determine the target frequencies 148 and/or the target flow rates 158 by performing a lookup in the lookup table using the rheological parameters 105. In this regard, the controller 108 may be considered to include software which automatically determines the target frequencies 148 and/or the target flow rates 158.

In embodiments, the slipform mold 102 may include multiple of the rheometers 130. The controller 108 may receive the rheological parameters 105 from the multiple of the rheometers 130. The controller 108 may perform a weighted average of the rheological parameters 105 when determining the target frequencies 148. Alternatively, the controller 108 may segment the target frequencies 148 based on a position of the rheometers 130 and the hydraulic vibrators 118. For example, the slipform mold 102 may include one of the rheometers 130 on a left-side and one of the rheometers 130 on a right-side of the slipform mold 102. The controller 108 may determine the target frequencies 148 and/or the target flow rates 158 for the hydraulic vibrators 118 which are on the left-side and the right-side of the slipform mold 102 based on the rheological parameters 105 from the rheometers 130 on the left-side and the right-side, respectively, of the slipform mold 102. In this regard, the target flow rates 158 and/or the target frequencies 148 may or may not be the same along the width of the slipform mold 102.

The paving machine 100 may include the frame 104. The frame 104 may also be referred to as a framework, a chassis, or the like. The frame 104 may include one or more members. In some embodiments, the frame 104 may include an adjustable width, although this is not intended to be limiting. For example, one or more of the members of the frame may be telescopic (e.g., via one or more roller bearings).

The paving machine 100 may be a two-track machine, a three-track machine, or a four-track machine. The paving machine 100 may include the end structures 106. The paving machine 100 may include at least two of the end structures 106. For example, the paving machine 100 may include two, three, or four (as depicted) of the end structures 106. The end structures 106 may be coupled to the frame 104. For example, the end structures 106 may be coupled directly to the frame 104 or coupled to the frame 104 via the pivot arms 116. The end structures 106 may support at least a portion of the frame 104. In this regard, the end structures 106 may be configured to support from 10,000 pounds to 27,000 pounds, or more.

The end structures 106 may include a leg assembly 112. The leg assembly 112 may be configured to adjust a height of the frame 104 relative to a ground surface. The leg assembly 112 may include an outer tube portion and an inner tube portion coupled by a linear actuator. The outer tube portion and the inner tube portion may be configured to telescope relative to one another. The linear actuator may include a hydraulic cylinder. The hydraulic cylinder may be a smart cylinder including one or more position transducers for determining a height of the leg assembly 112. The position transducers may include a linear transducer (e.g., a wand and wiper assembly) for monitoring a displacement of the hydraulic cylinder, although this is not intended to be limiting. The leg assembly 112 may include any leg assembly known in the art. For example, the leg assembly 112 may be like a leg assembly described in U.S. Pat. No. 9,764,762, titled ROTARY PIVOT ARM POSITIONING ASSEMBLY, which is incorporated herein by reference in the entirety. By way of another example, the leg assembly 112 may be like a leg assembly described in U.S. Pat. No. 11,254,359, titled LEG ASSEMBLY FOR CONSTRUCTION MACHINE, which is incorporated herein by reference in the entirety.

The end structures 106 may include a track section 114. The track section 114 may also be referred to as a crawler assembly, a continuous track, or a caterpillar track, among other names. The track section 114 may be disposed below the leg assembly 112 and coupled to the leg assembly 112. For example, the track section 114 may be coupled to the leg assembly 112 by a yoke, a slew drive, or the like. Power may be supplied from the hydraulic power supply 110 to the track section 114 (e.g., to a track drive of the track section). In response to receiving the power, the track drive may turn an endless track of the track section 114. By turning the endless track, the paving machine 100 may be propelled in the paving direction. The track drive may also be used to assist in pivoting the pivot arms 116 (i.e., pivoting on-the-go, stationary pivoting, crab steer, etc.). Thus, the paving machine 100 may be adapted to move in a paving direction by the end structures 106. The controller 108 may control a speed of the paving machine 100 using the track sections 114.

In embodiments, the controller 108 may control the speed of the paving machine 100 based on the rheological parameters 105 measured by the rheometers 130. For example, the controller 108 may control the track drive of the track section 114 based on the rheological parameters 105. Where the rheological parameters 105 indicate the concrete 101 is easily workable, the speed of the paving machine 100 may be increased. Where the rheological parameters 105 indicate the concrete 101 is hard to work, the speed of the paving machine 100 may be decreased.

The paving machine 100 may include pivot arms 116. The pivot arms 116 may pivotably connect the end structures 106 with the frame 104. In this regard, each pivot arms 116 may be coupled with an end structures 106. The pivot arms 116 may be coupled in any manner, such as, but not limited to, a slew drive, a ratcheting assembly, a four-bar-linkage configuration of a hydraulic cylinder, or a planetary drive. Although the paving machine 100 is described as including the pivot arms 116, this is not intended as a limitation of the present disclosure. For example, the two-track paver machine may or may not include the pivot arms 116. Furthermore, although the paving machine 100 is depicted as a four-track paving machine, this is not intended as a limitation of the present disclosure. It is further contemplated that the paving machine 100 may be a two-track and/or a three-track paving machine. For example, the paving machine 100 may be a two-track paving machine. The two-track paving machine may include two of the end structures 106 and may not include the pivot arms 116. By way of another example, the paving machine 100 may be a three-track paving machine. The three-track paving machine may include three of the end structures 106 and one or more of the pivot arms 116. For example, one or more of the end structures 106 may be coupled to the frame 104 by the pivot arms 116.

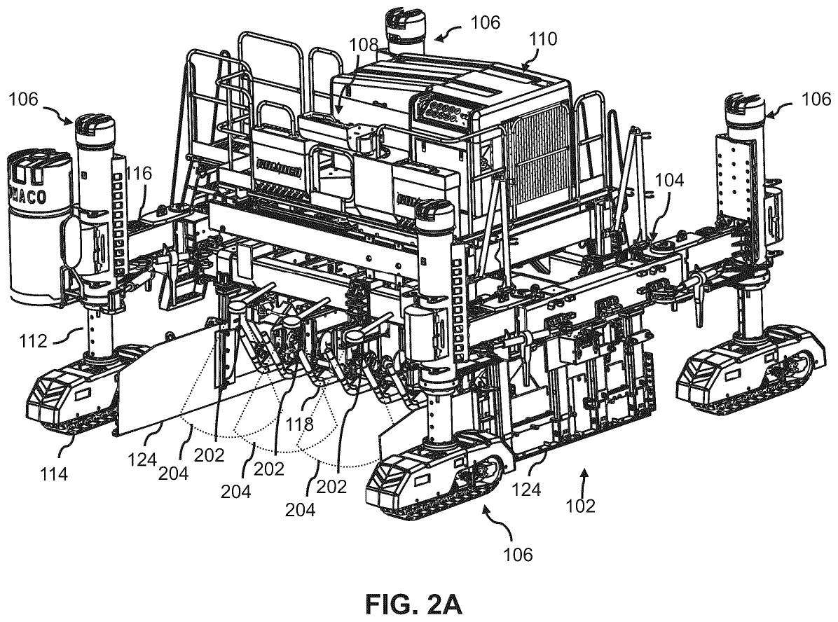

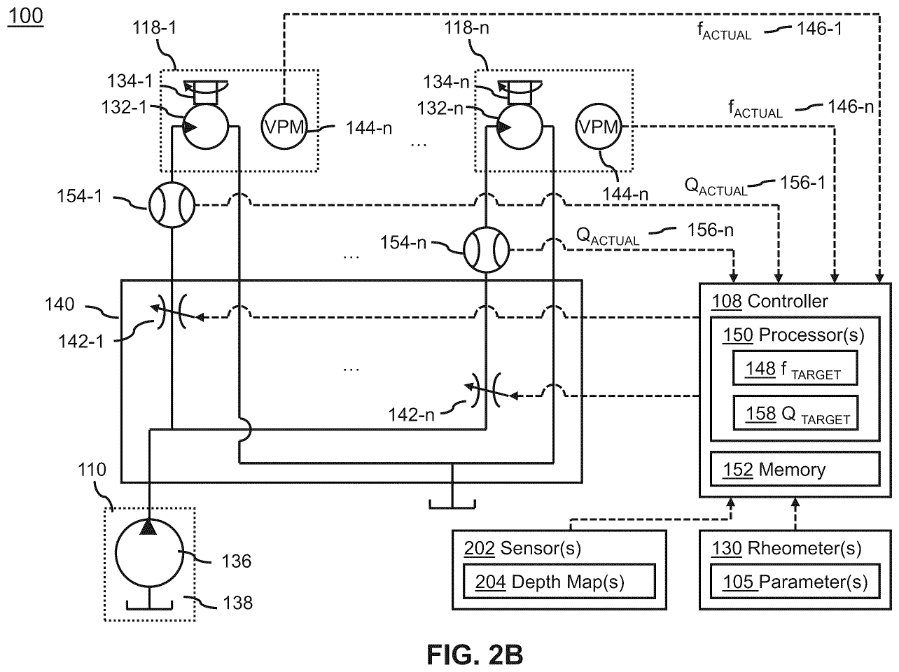

Referring now to FIGS. 2A-2B, the paving machine 100 is described in accordance with one or more embodiments of the present disclosure. The paving machine 100 may also include depth sensors 202. The depth sensors 202 may be configured to generate a stream of depth maps 204. The depth maps 204 may be depth maps from the depth sensors 202 to the concrete 101.

The controller 108 may receive the depth maps 204 from the depth sensors 202. The controller 108 may determine the rheological parameters 105 of the concrete 101 based on the depth maps 204. For example, the depth to the concrete 101 may vary over time. For instance, the concrete 101 may flow (e.g., slump downwards), thereby changing the depth, where the flow may be based on the rheological parameters. The change in the depth may be used to determine the rheological parameters 105.

The depth sensors 202 may be oriented to capture the depth maps 204 of the concrete 101. For example, the depth sensors 202 may be coupled to one or more of the frame 104, the pivot arms 116, the leg assembly 112, or the track section 114. The depth sensors 202 may be coupled to the frame 104 and disposed above the hydraulic vibrators 118. The depth maps 204 may thus include the concrete 101 before consolidation into the slab 103. In some instances, the depth sensors may have a reduced ability to generate the depth map when covered in particles such as dirt, dust, or concrete. It is contemplated that the depth sensors may be mounted to avoid the particles. For example, the depth sensors 202 may be mounted high enough on the paving machine 100 to avoid the particles with a bird's eye view pointed downwards on the concrete. It is further contemplated that the depth sensors 202 may function even when covered by the particles. For example, the depth sensors 202 may use a wavelength to generate the depth maps 204 which may pass through the particles.

The depth sensors 202 may include a field-of-view (FOV). The field-of-view of the depth sensors 202 may or may not overlap.

The depth sensors 202 may be used in combination with or in place of the rheometers 130 to determine the rheological parameters 105.

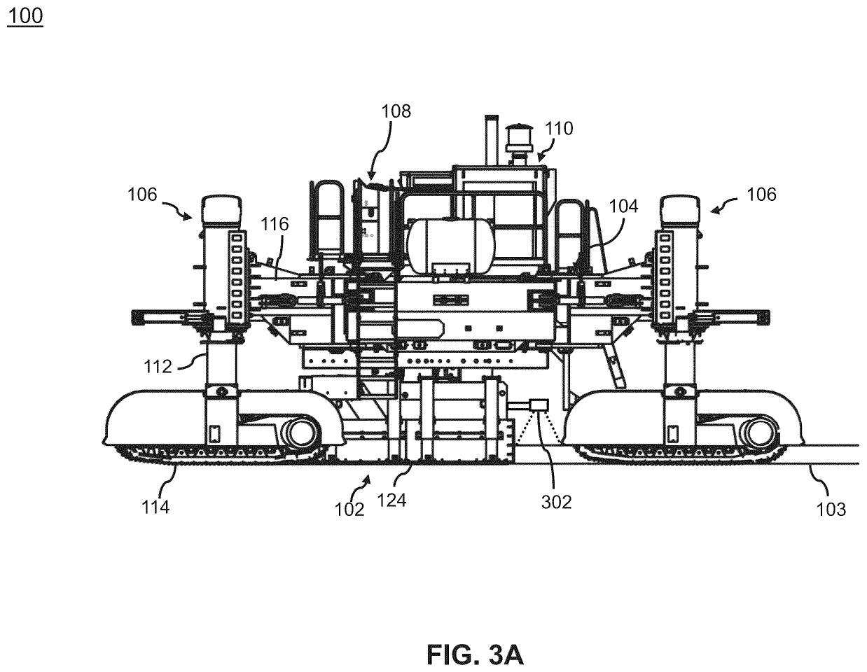

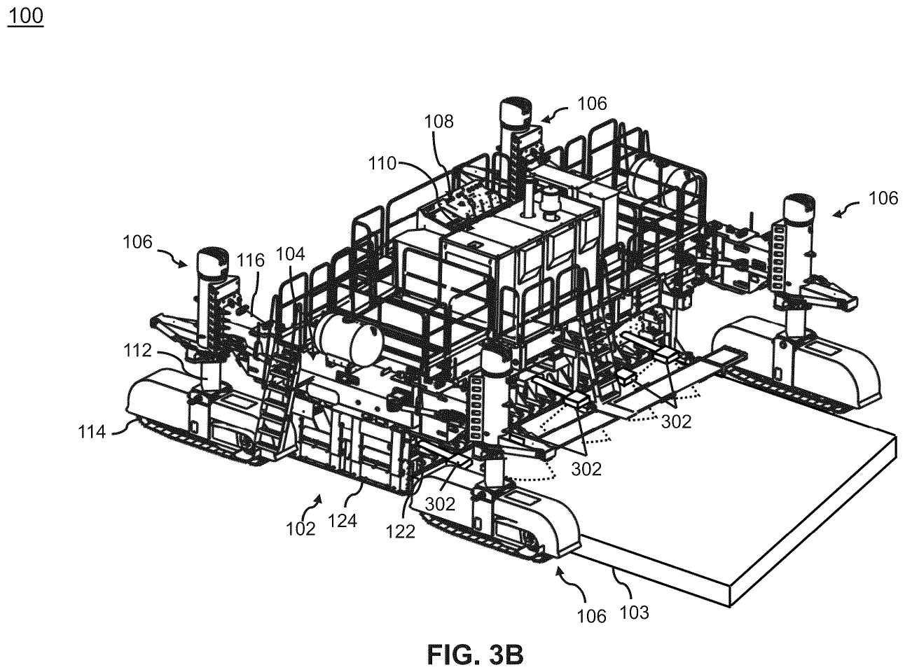

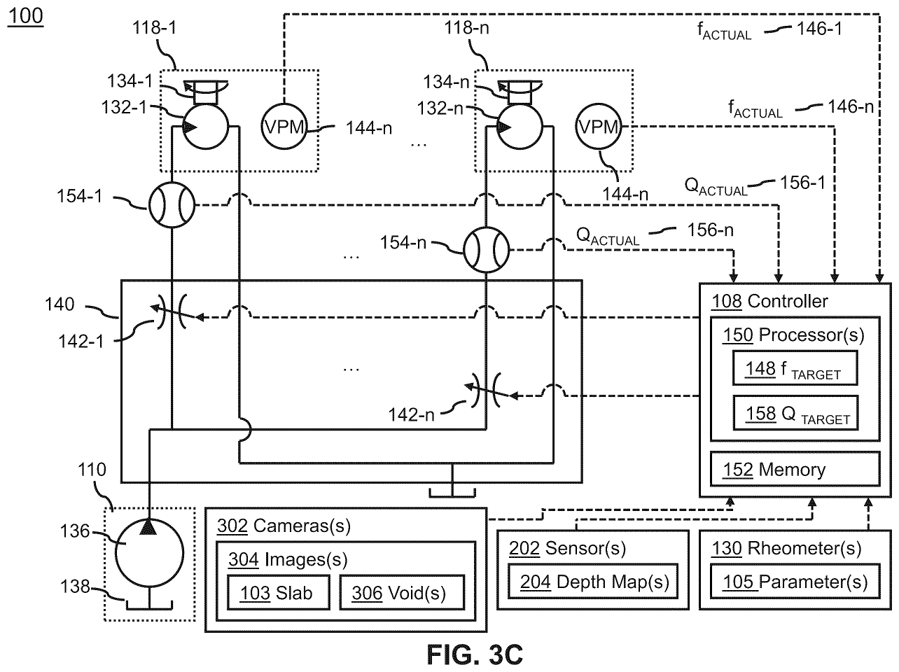

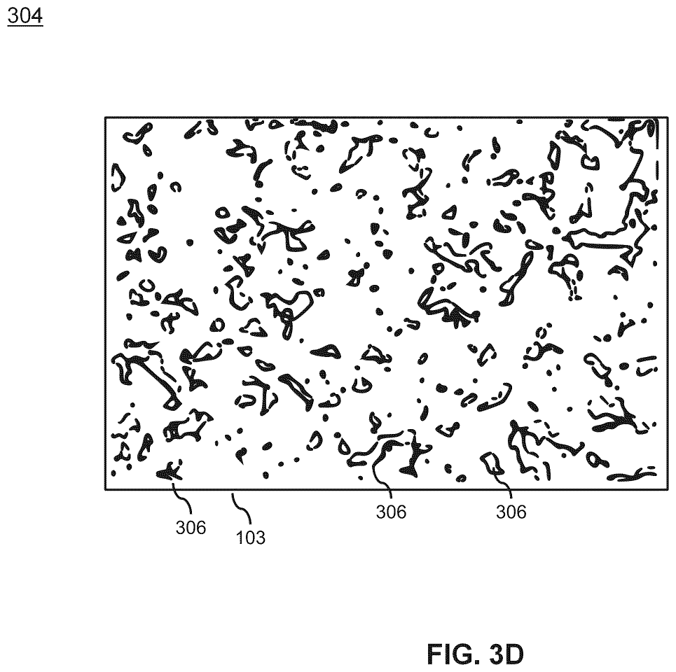

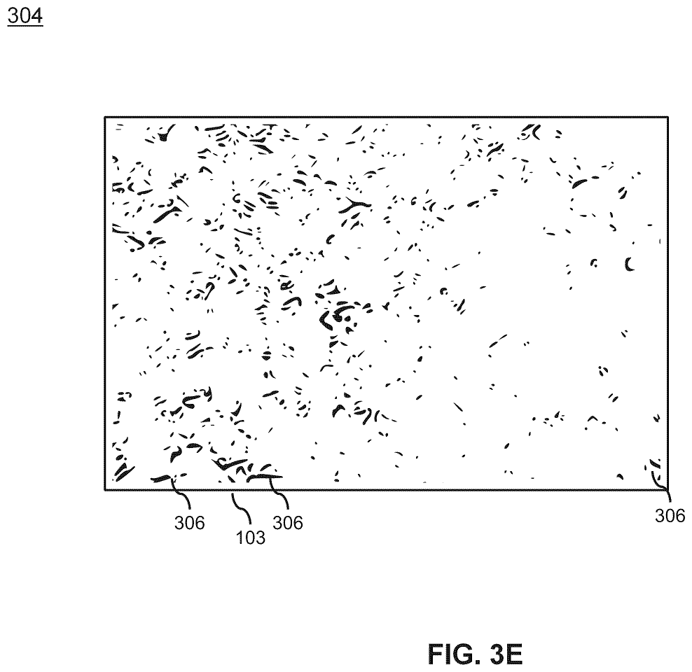

Referring now to FIGS. 3A-3E, the paving machine 100 is described, in accordance with one or more embodiments of the present disclosure. In embodiments, the slab 103 may define surface voids 306. The surface voids 306 may be defined by a top surface of the slab 103. The surface voids 306 may also be referred to as surface air voids, pitting, cavities, and the like. A size of the surface voids 306 may be based on the rheological parameters 105 of the concrete 101 and/or the actual frequencies 146 of the hydraulic vibrators 118 at which the slab 103 is consolidated. For example, larger of the surface voids 306 may indicate that the actual frequencies 146 of the hydraulic vibrators 118 at which the slab 103 was consolidated was insufficient.

In embodiments, the paving machine 100 may include cameras 302. The cameras 302 may be configured to generate images 304. The images 304 may be images of the top surface of the slab 103. The images 304 may include the slab 103 and the surface voids 306. The images 304 from the cameras 302 may include the slab 103 immediately upon exiting the slipform mold 102. The cameras 302 may be located at one or more positions to generate the images 304 of the top surface of the slab 103, such as, but not limited to, suspended above the slab 103. For example, the cameras 302 may be coupled to the frame 104 above the slipform mold 102. The cameras 302 may be disposed adjacent to a rear end of the slipform mold 102. For example, the cameras 302 may be longitudinally disposed between the rear end of the slipform mold 102 and an operator walkway of the paving machine 100.

The controller 108 may receive the images 304 from the cameras 302. The controller 108 may detect the surface voids 306 in the images 304. For example, the controller 108 may detect the surface voids 306 by detecting a contrast between the surface voids 306 and the slab 103, by performing one or more image recognition algorithms on the images 304, or the like. In embodiments, the controller 108 may detect a size, a quantity, or the like of the surface voids 306 in the images 304.

In embodiments, the controller 108 may dynamically update the target frequencies 148 and/or the target flow rates 158 based on the surface voids 306 detected in the images 304. For example, the controller 108 may increase the target flow rates 158 and/or the target frequencies 148 to decrease the size of the surface voids 306 in subsequent of the images 304. Thus, the surface voids 306 detected in the images 304 may be used to estimate rheological parameters 105 of the concrete 101 after forming the slab 103. Updating the target flow rates 158 and/or the target frequencies 148 based on the surface voids 306 may be considered reactionary (e.g., after forming), as opposed to methods described above where the target flow rates 158 and/or the target frequencies 148 are dynamically updated based on the rheological parameters 105 determined by the rheometers 130 prior to forming the concrete 101 into the slab 103.

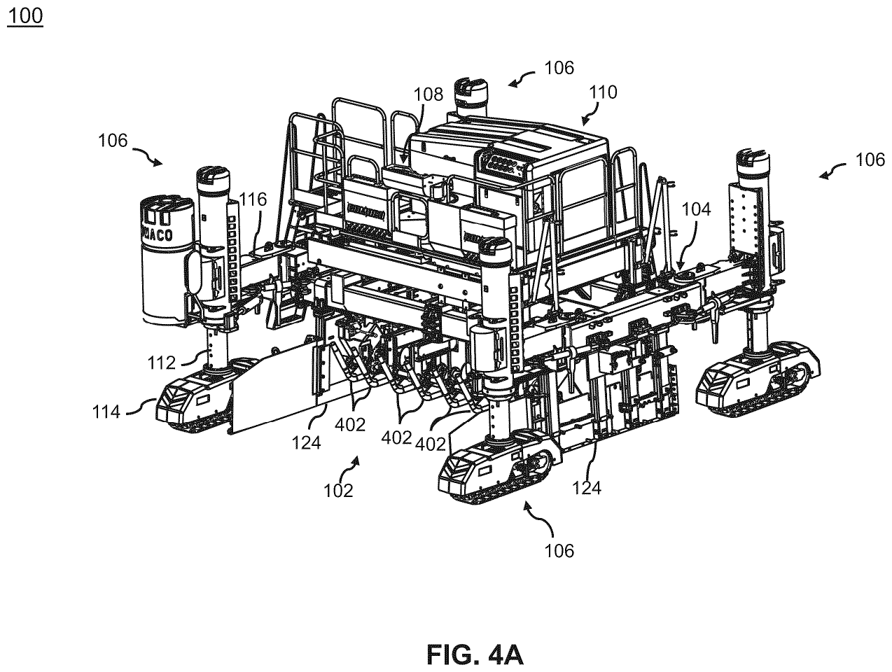

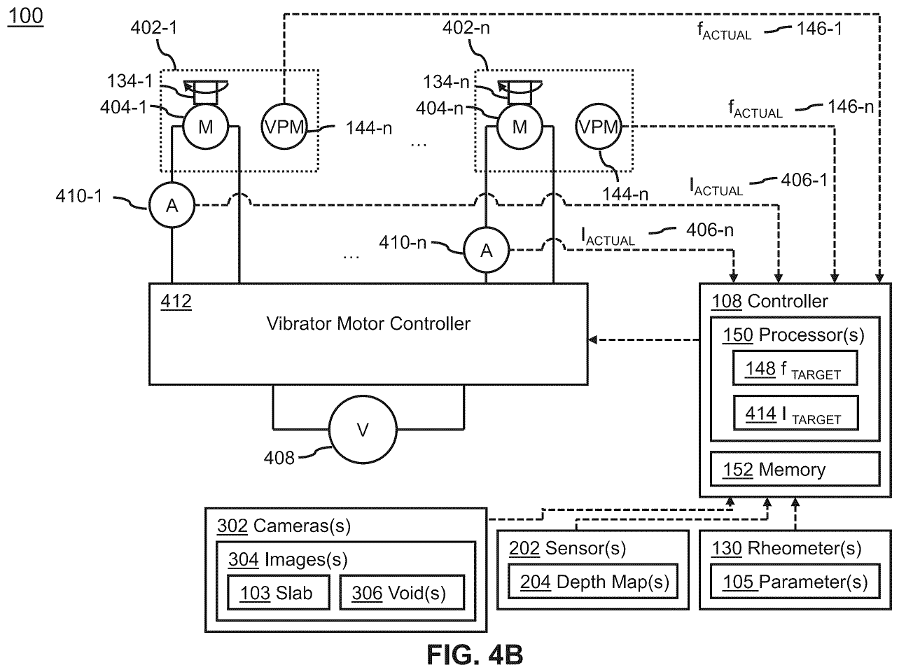

Referring now to FIGS. 4A-4B, the paving machine 100 is described, in accordance with one or more embodiments of the present disclosure. Although the paving machine 100 is described as including the hydraulic vibrators 118, this is not intended as a limitation of the present disclosure. In embodiments, the paving machine 100 may include electric vibrators 402, electric power source 408, current meters 410, vibrator motor controller 412, and the like. The discussion of the hydraulic vibrators 118 is incorporated herein by reference as to the electric vibrators 402 with appropriate modification from hydraulic to electric. For example, all discussion of controlling the flow rate to the hydraulic vibrators 118 may be modified for the hydraulic vibrators 118 by replacing the flow rate with a current flow to the electric vibrators 402. In this regard, the various embodiments of controlling the hydraulic vibrators 118 based on the rheological parameters 105, the depth maps 204, the images 304, and the like may similarly apply to controlling the electric vibrators 402 based on the rheological parameters 105, the depth maps 204, the images 304, and the like.

The electric vibrators 402 may include an electric motor 404 and the eccentric weight 134. The electric motor 404 may receive electric power from the electric power source 408. The electric motor 404 may cause the eccentric weight 134 to vibrate in response to receiving the electric power. The electric motor 404 may receive an actual current 406 (I_{ACTUAL}) at a voltage, thereby defining the electric power. The electric motor 404 may vibrate the eccentric weight 134 at the actual frequencies 146 (f_{ACTUAL}) in response to receiving the actual current 406. Increases in the actual current 406 will, in turn, create an increase in the actual frequencies 146. For example, the actual frequencies 146 may scale linearly with the actual current 406.

The paving machine 100 may include current meters 410. The current meters 410 may be coupled between the vibrator motor controller 412 and the electric vibrators 402.

The vibrator motor controller 412 may be coupled between the electric power source 408 and the electric vibrators 402. The vibrator motor controller 412 may control the actual current 406 to the electric vibrators 402. The vibrator motor controller 412 may receive electrical signals from the controller 108, causing the vibrator motor controller 412 to control the actual current 406 from the electric power source 408 to the electric vibrators 402. The actual frequencies 146 of the electric vibrators 402 may be controlled by varying the actual current 406 to the electric vibrators 402. The vibrator motor controller 412 may also control the voltage to the electric motors 404, thereby controlling the amplitude of the eccentric weights 134.

The controller 108 may receive the actual current 406 from the current meters 410 and/or the actual frequencies 146 from the vibration sensors 144.

The controller 108 may use the actual current 406 and/or the actual frequencies 146 as feedback when adjusting the actual current 406 to the electric vibrators 402, thereby moving the actual current 406 towards a target current 414 and/or the actual frequencies 146 towards the target frequencies 148. The controller 108 may cause the vibrator motor controller 412 to control the actual current 406 to the electric vibrators 402 towards target frequencies 148 using the actual current 406 as feedback.

In embodiments, the paving machine 100 may include electric vibrators 402-1 through 402-n. Each of the electric vibrators 402-1 through 402-n may include a respective of the electric motors 404-1 through 404-n, the eccentric weights 134-1 through 134-n, and the like. Similarly, each of the electric vibrators 402-1 through 402-n may receive a respective of the actual currents 406-1 through 406-n and may vibrate at respective of the actual frequencies 146-1 through 146-n. The current meters 410 may include current meters 410-1 through 410-n coupled between the vibrator motor controller 412 and respective of the electric vibrators 402-1 through 402-n. The current meters 410-1 through 410-n may measure the actual current 406-1 through 406-n.

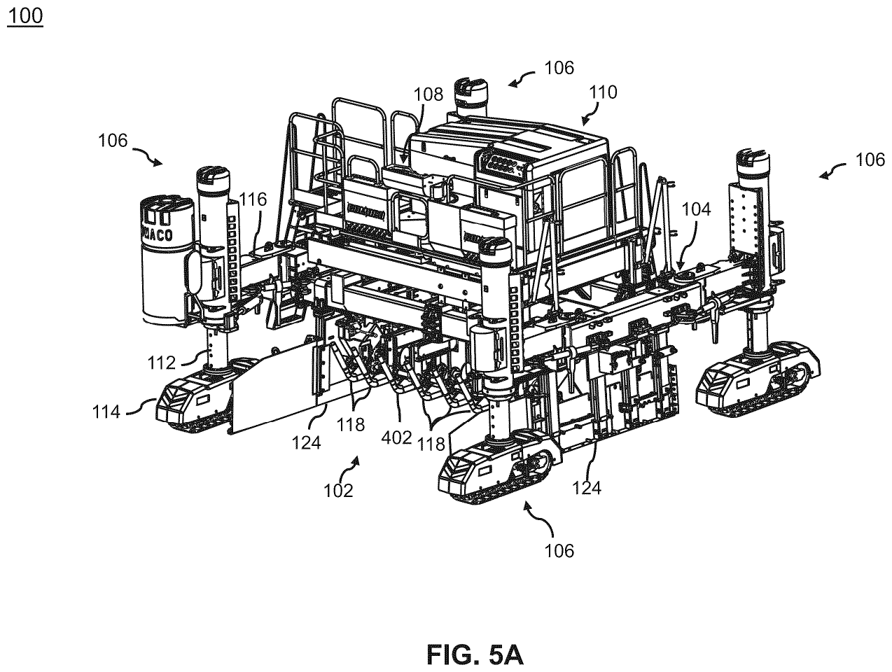

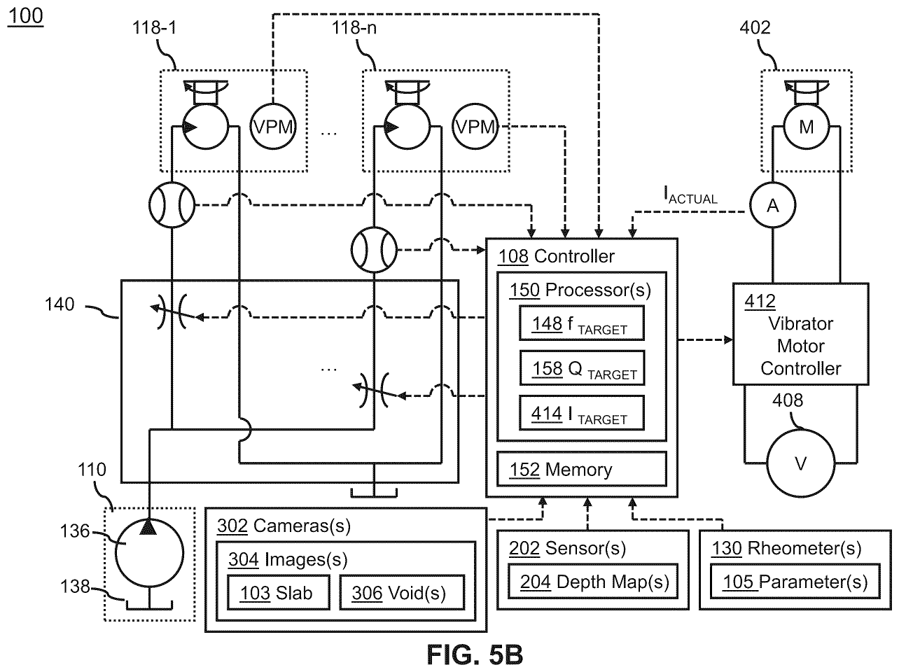

Referring now to FIGS. 5A-5B, the paving machine 100 is described, in accordance with one or more embodiments of the present disclosure. In embodiments, the paving machine 100 may include the hydraulic vibrators 118-1 through 118-n and one or more of the electric vibrators 402. For example, the electric vibrators 402 may be one vibrator in a bank of the hydraulic vibrators 118.

The electric vibrators 402 may be considered a sensor vibrator. In embodiments, the vibrator motor controller 412 may set the electric vibrators 402 at a fixed voltage and a fixed vibrator frequency. The current meter 410 may measure the actual current 406 at the fixed voltage and the fixed vibrator frequency. The actual current 406 may correspond to the rheological parameters 105. For example, if the concrete 101 is easier to work at the fixed voltage and a fixed vibrator frequency then the actual current 406 may decrease. By way of another example, if the concrete 101 is harder to work at the fixed voltage and a fixed vibrator frequency then the actual current 406 may increase.

The controller 108 may receive the measurement of the actual current 406 from the current meter 410 and dynamically update the target frequencies 148 and/or the target flow rates 158 of the hydraulic vibrators 118 based on the measurement of the actual current 406 to the electric vibrators 402.

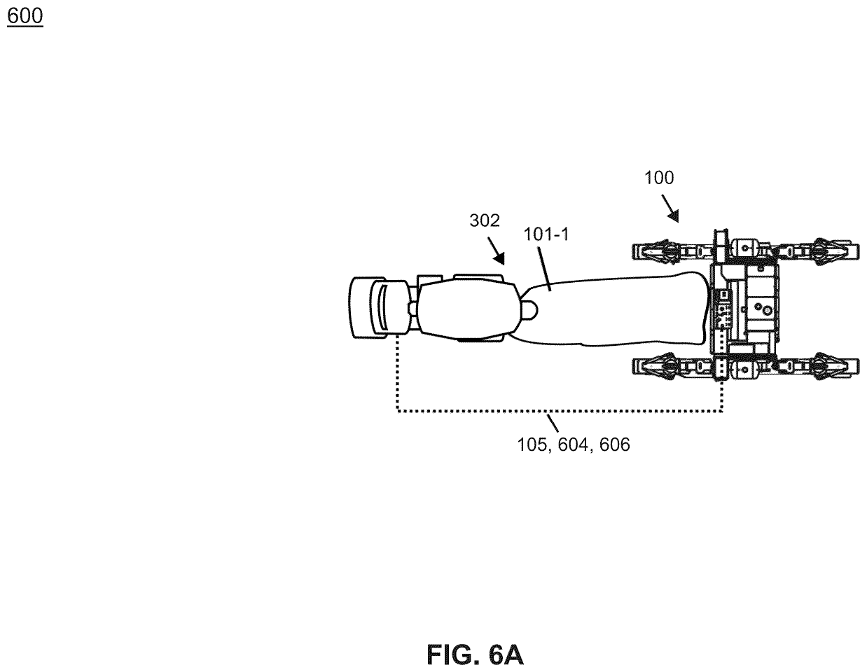

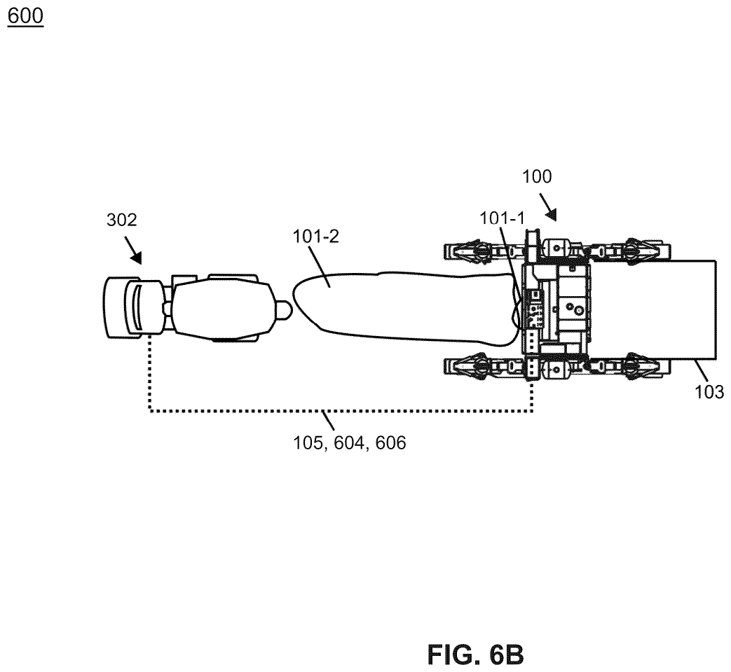

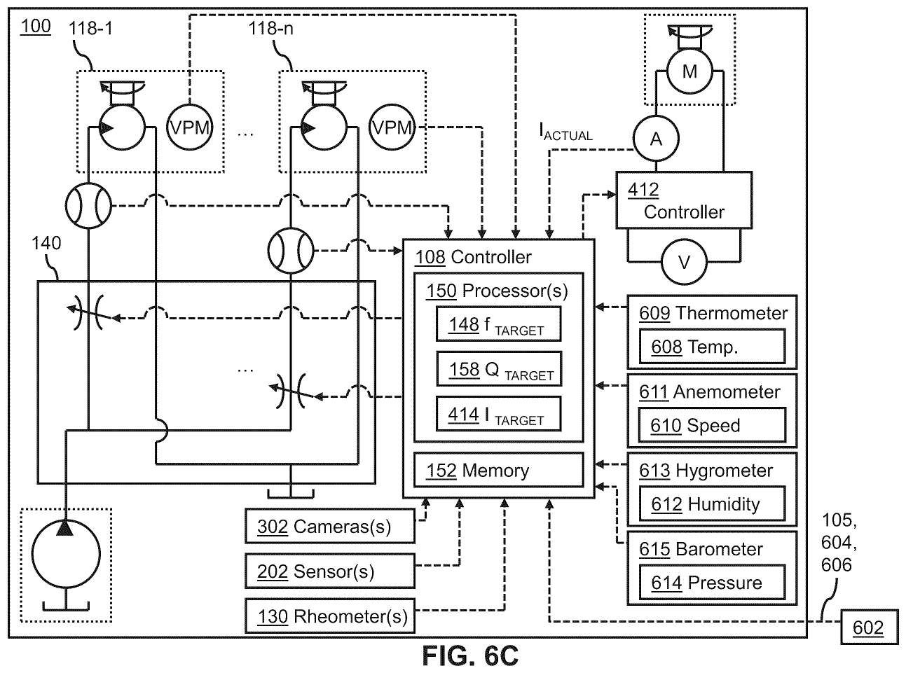

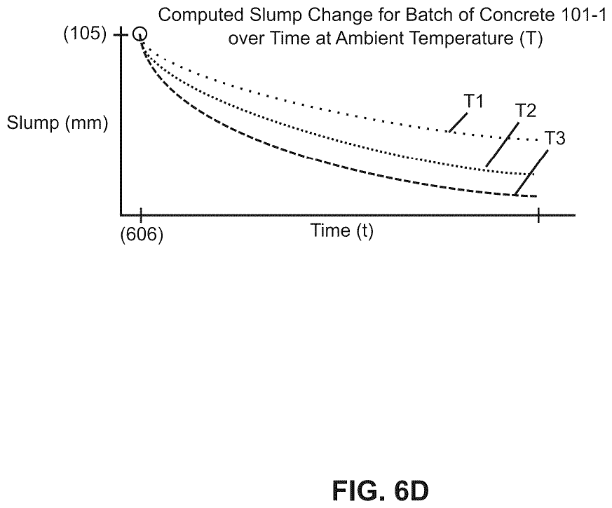

Referring now to FIGS. 6A-6D, a system 600 is described, in accordance with one or more embodiments of the present disclosure. The system 600 may include the paving machine 100 and a mixer truck 602. The mixer truck 602 may place the concrete 101 in front of the paving machine 100. The paving machine 100 may be communicatively coupled to the mixer truck 602. The paving machine 100 (e.g., the controller 108) may receive the rheological parameters 105 of the concrete 101 from the mixer truck 602, a placement position 604 at which the mixer truck 602 has placed the concrete 101, and/or a placement time 606 at which the mixer truck 602 has placed the concrete 101. The mixer truck 602 may determine the rheological parameters 105 based on one or more of a rotational speed of the mixer truck, a mass of the concrete 101 in the mixer truck 602, a shear rate of the concrete 101, and the like.

In embodiments, the controller 108 may receive the rheological parameters 105, the placement position 604, and/or the placement time 606. The controller 108 may then dynamically update the target flow rates 158, the target frequencies 148, the target current 414, and the like based on the rheological parameters 105, the placement position 604, and/or the placement time 606. For example, the controller 108 may account for changes in the rheological parameters 105 between batches of the concrete 101 (e.g., batch of concrete 101-1, 101-2) based on the placement position 604 and the current position of the paving machine 100. By way of another example, the controller 108 may account for changes in the rheological parameters 105 due to time elapsing since the placement time 606. For instance, the water content of the concrete 101 may decrease (e.g., causing slump loss) based on time exposed on the ground before being formed. Thus, the controller 108 may dynamically update the target flow rates 158, the target frequencies 148, the target current 414, and the like based on the information received from the mixer truck to further include a reference to position and time of day for where and when the concrete was placed, since the rheological parameters 105 may change over time.

One or more meteorological parameters may change the rate at which the water content of the concrete 101 decreases between the placement time 606 and the time at which the paving machine 100 consolidates the concrete 101 into the slab 103. The meteorological parameters may include ambient temperature 608, wind speed 610, humidity 612 (e.g., absolute humidity, relative humidity, or specific humidity), air pressure 614, and the like. The rate at which the water content of the concrete 101 decreases may be proportional to the ambient temperature 608, proportional to the wind speed 610, inversely proportional to the humidity 612, and/or inversely proportional to the air pressure 614. With an increase in the ambient temperature 608, an increase in the wind speed 610, a decrease in the humidity 612, and/or a decrease in the air pressure 614, the concrete 101 may experience higher loss of water content due to evaporation such that the workability may decrease as compared to concrete 101 which is exposed to a lower ambient temperature, a lower wind speed, a higher humidity, and/or a higher air pressure over the same period. In this regard, the rate of change of the rheological parameters 105 of the concrete 101 over time after being placed by the mixer truck 602 in front of the paving machine 100 may be dependent upon the ambient temperature 608, the wind speed 610, the humidity 612, and/or the air pressure 614.

In embodiments, the controller 108 may receive the meteorological parameters. For example, the controller 108 may receive the ambient temperature 608, wind speed 610, humidity 612, air pressure 614, and the like. The paving machine 100 may include one or more meteorological sensors by which the controller 108 may receive the meteorological parameters, such as, but not limited to, an ambient temperature sensor (e.g., thermometer 609), a wind speed sensor and/or wind direction sensor (e.g., anemometer 611), a humidity sensor (e.g., hygrometer 613), an air pressure sensor (e.g., barometer 615), and the like. The thermometer 609, the hygrometer 613, and the barometer 615 may measure the ambient temperature 608, wind speed 610, humidity 612, and air pressure 614, respectively.

The controller 108 may dynamically update the rheological parameters 105 received from the mixer truck 602 based on the placement time 606 in combination with the ambient temperature 608, wind speed 610, humidity 612, and/or the air pressure 614. The controller 108 may then control the target flow rates 158, the target frequencies 148, the target current 414, and the like based on the rheological parameters 105 which has been updated. Thus, the controller 108 may compensate for the change in the water content when controlling the hydraulic vibrators 118 and/or the electric vibrators 402.

Although not depicted, the system 600 may further include one or more placer/spreaders to place and/or spreader the concrete 101 from the mixer truck 602 in front of the paving machine 100.

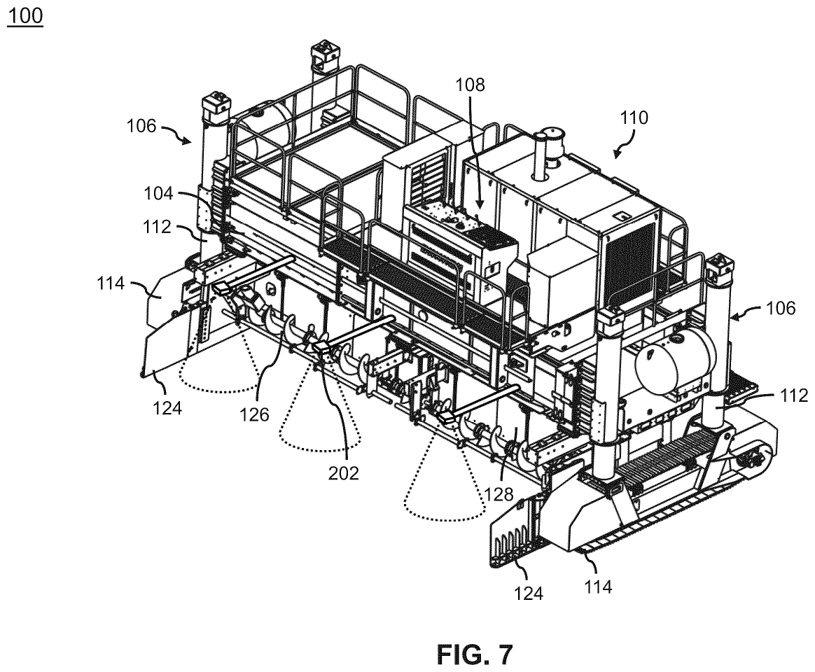

FIG. 7 depicts the paving machine 100, in accordance with one or more embodiments of the present disclosure. In this example, the paving machine 100 is configured as a two-track machine with two of the end structures 106. The paving machine is also configured with the split front auger 126, although this is not intended to be limiting. The two-track machine may be configured with any of the various embodiments, such as the rheometers 130, the depth sensors 202, the cameras 302, the sensor vibrators, and the like.

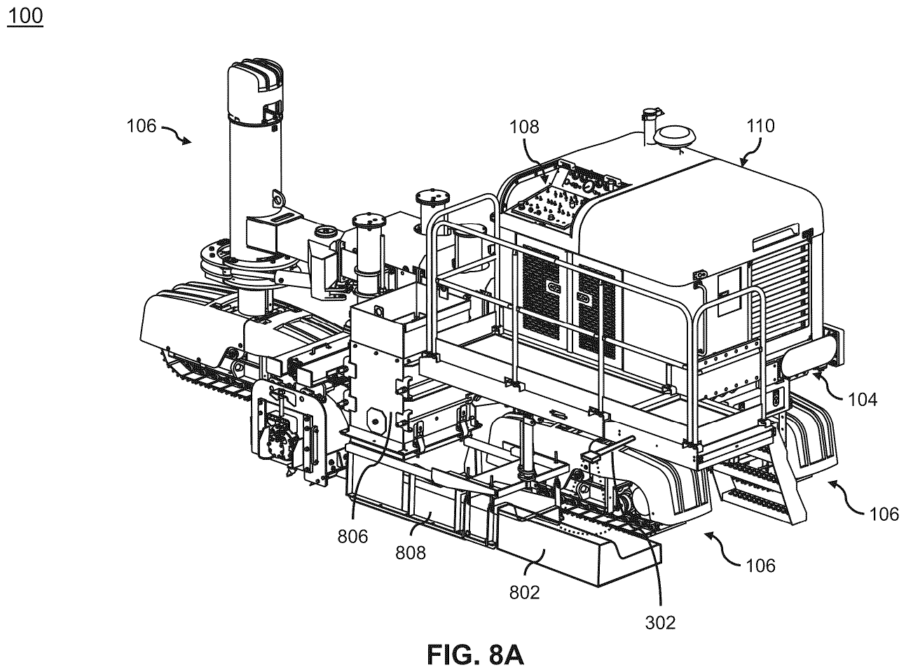

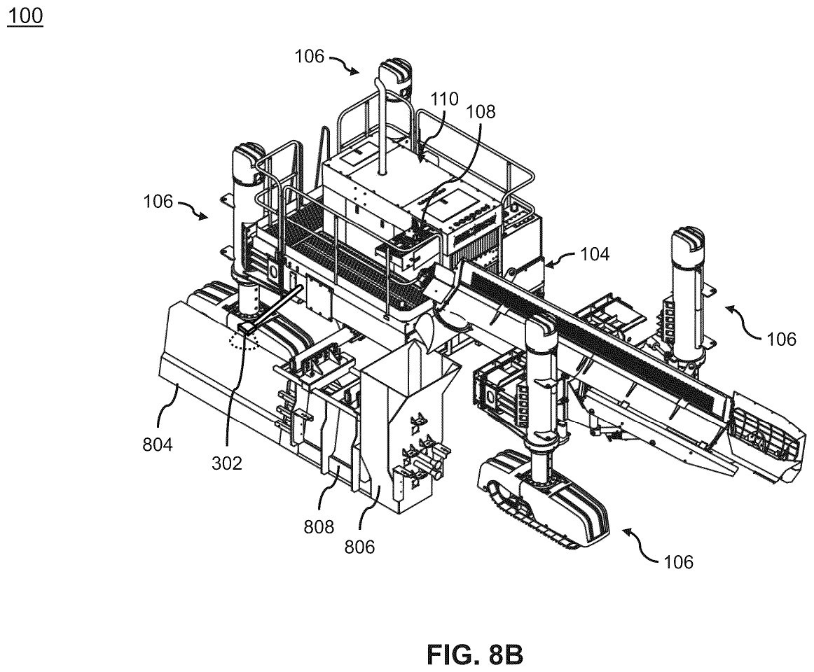

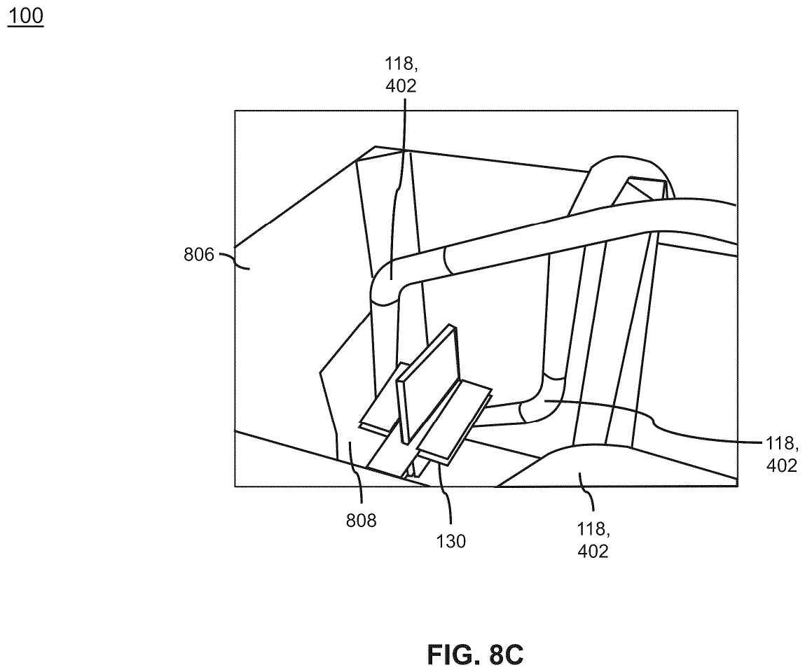

FIGS. 8A-8C depict the paving machine 100, in accordance with one or more embodiments of the present disclosure. Although much of the present disclosure has described the paving machine 100 as a slipform paver with the slipform mold 102 configured to form the slab 103, this is not intended as a limitation of the present disclosure. The paving machine 100 may be a curb-and-gutter paving machine (see FIG. 8A, configured as a three-track machine), a barrier paving machine (see FIG. 8B, configured as a four-track machine), a sidewalk paving machine, or the like. The slipform mold 102 may be mounted to a side of the frame 104. The slipform mold 102 may be an offset mold mounted to the side of the frame 104. The slipform mold 102 may be mounted in either a right-hand pour or left-hand pour configuration. The slipform mold 102 may be configured to form the concrete 101 into a curb-and-gutter 802, a barrier 804, or the like as the paving machine 100 travels in the paving direction. The slipform mold 102 may form the curb-and-gutter 802 and/or the barrier 804 in a continuous operation.

The slipform mold 102 include a hopper 806. The hopper 806 may also be referred to as a chute. The slipform mold 102 may also include a forming section 808. The forming section 808 may be disposed behind the hopper 806 in the paving direction. The forming section 808 may receive the concrete 101 from the hopper 806. The forming section 808 may form the curb-and-gutter 802 and/or the barrier 804. The forming section 808 may include any suitable profile for forming the material into the curb-and-gutter 802, such as, but not limited to, straight curbs, mower curbs, or slanted curbs. Similarly, the forming section 808 may include any suitable profile for forming the material into the barrier 804, such as, but not limited to, a median barrier, parapet barrier, or the like.

The hydraulic vibrators 118 may be immersion vibrators which may be affixed within the hopper 806. The hydraulic vibrators 118 may be disposed a select distance away from the walls of the hopper 806. The hydraulic vibrators 118 may be disposed at a height aligned with the concrete 101 in the forming section 808.

The paving machine 100 with the slipform mold 102 in the offset configuration may include any of the various embodiments for determining the rheological parameters 105, such as the rheometers 130, the cameras 302, the sensor vibrators, and the like. For example, the rheometers 130 may be disposed within the hopper 806. The hopper 806 may constrain the concrete 101, enabling the rheometers 130 to measure the rheological parameters 105 as the concrete 101 falls down the hopper 806 into the forming section 808. By way of another example, the cameras 302 may be coupled to a side of the frame 104 behind the slipform mold 102 in the paving direction for generating the images 304. By way of another example, the electric vibrators 402 may be disposed within the hopper 806 for sensing the rheological parameters 105. The electric vibrators 402 may replace one or more of the hydraulic vibrators 118 in existing of the slipform molds 102.

It is contemplated that the paving machine 100 with the slipform mold 102 in the offset configuration may or may not include the depth sensors 202. For example, the concrete 101 is not poured ahead of the slipform mold 102, such that the depth sensors 202 may not function in the offset configuration.

Referring generally again to the figures. As may be understood, the specific components of the hydraulic circuit, sub-circuits, and the paths to/from the hydraulic sub-circuits of the paving machine 100 are not provided for clarity. It is further contemplated that the paving machine 100 may include hydraulic components, such as, but not limited to, inlet manifolds, outlet manifolds, hydraulic motors, hydraulic cylinders, filters, check valves, relief valves, and the like.

The slipform mold 102 may or may not include an adjustable width. The slipform mold 102 may be a fixed width mold, an adjustable width, or the like. For example, the slipform mold 102 may be an adjustable width paving mold. The width between the side plates 124 may be adjustable. The adjustable width paving mold may provide the paving machine 100 with an ability to form tapered slabs on-the-go by a paving width change. The adjustable width paving mold may include a hydraulically telescoping rolling frame with dual rollers.

In the case of a control algorithm, one or more program instructions or methods may be configured to operate via proportional control, feedback control, feedforward control, integral control, proportional-derivative (PD) control, proportional-integral (PI) control, proportional-integral-derivative (PID) control, or the like.

The controller 108 may be communicatively coupled with one or more electronic components of the paving machine 100. For example, the controller 108 may be communicatively coupled with the hydraulic vibrators 118 (e.g., vibration sensors 144), the hydraulic manifold 140 (e.g., adjustable flow control valves 142), and/or the rheometers 130. The controller 108 may be communicatively with the electronic components by one or more controller area network buses or the like.

The controller may be a mobile machine control computer, a desktop computer, workstation, parallel processor, or other computer system configured to execute a program configured to operate the paving machine 100, as described throughout the present disclosure.

As may be understood, the processors may include any one or more processing elements known in the art. In this sense, the processors may include any microprocessor-type device configured to execute software algorithms and/or instructions. For the purposes of the present disclosure, the term “processor” or “processing element” may be broadly defined to encompass any device having one or more processing or logic elements (e.g., one or more micro-processor devices, one or more application specific integrated circuit (ASIC) devices, one or more field programmable gate arrays (FPGAs), or one or more digital signal processors (DSPs)). In this sense, the one or more processors may include any device configured to execute algorithms and/or instructions (e.g., program instructions stored in memory).

Furthermore, the memory may include any storage medium known in the art suitable for storing program instructions executable by the associated one or more processors. For example, the memory medium may include a non-transitory memory medium. By way of another example, the memory medium may include, but is not limited to, a read-only memory (ROM), a random-access memory (RAM), a magnetic or optical memory device (e.g., disk), a solid-state drive and the like. It is further noted that memory medium may be housed in a common controller housing with the one or more processors. In one embodiment, the memory medium may be located remotely with respect to the physical location of the one or more processors.

All of the methods described herein may include storing results of one or more steps of the method embodiments in memory. The results may include any of the results described herein and may be stored in any manner known in the art. The memory may include any memory described herein or any other suitable storage medium known in the art. After the results have been stored, the results can be accessed in the memory and used by any of the method or system embodiments described herein, formatted for display to a user, used by another software module, method, or system, and the like. Furthermore, the results may be stored “permanently,” “semi-permanently,” temporarily,” or for some period of time. For example, the memory may be random access memory (RAM), and the results may not necessarily persist indefinitely in the memory. It is further contemplated that each of the embodiments of the method described above may include any other step(s) of any other method(s) described herein. In addition, each of the embodiments of the method described above may be performed by any of the systems described herein.

One skilled in the art will recognize that the herein described components operations, devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components, operations, devices, and objects should not be taken as limiting.

As used herein, directional terms such as “top,” “bottom,” “front,” “back,” “over,” “under,” “upper,” “upward,” “lower,” “down,” and “downward” are intended to provide relative positions for purposes of description, and are not intended to designate an absolute frame of reference. Various modifications to the described embodiments will be apparent to those with skill in the art, and the general principles defined herein may be applied to other embodiments.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. A paving machine comprising:
a slipform mold, wherein the slipform mold is configured to form concrete, wherein the slipform mold comprises:
a plurality of hydraulic vibrators, wherein the plurality of hydraulic vibrators are configured to vibrate in response to receiving hydraulic fluid; and
one or more rheometers, wherein the one or more rheometers are configured to measure rheological parameters of the concrete;
a hydraulic power supply comprising a hydraulic pump;
a hydraulic manifold, wherein the hydraulic manifold is coupled between the hydraulic pump and the plurality of hydraulic vibrators; and
a controller comprising one or more processors configured, via executable code, to:
cause the hydraulic manifold to control actual flow rates of the hydraulic fluid from the hydraulic pump to the plurality of hydraulic vibrators thereby controlling actual frequencies of the plurality of hydraulic vibrators; and
dynamically update at least one of target flow rates of the hydraulic fluid to the plurality of hydraulic vibrators or target frequencies of the plurality of hydraulic vibrators based on the rheological parameters.

2. The paving machine of claim 1, wherein the plurality of hydraulic vibrators comprise a plurality of vibration sensors, wherein the plurality of vibration sensors are configured to measure the actual frequencies of the plurality of hydraulic vibrators, wherein the controller is configured to use the actual frequencies as feedback when causing the hydraulic manifold to control the actual flow rates of the hydraulic fluid from the hydraulic pump to the plurality of hydraulic vibrators thereby controlling the actual frequencies of the plurality of hydraulic vibrators, wherein the actual frequencies are continuously updated towards the target frequencies based on the actual frequencies measured by the plurality of vibration sensors.

3. The paving machine of claim 1, wherein the paving machine comprises a plurality of flow meters, wherein the plurality of flow meters are configured to measure the actual flow rates, wherein the controller is configured to use the actual flow rates as feedback when causing the hydraulic manifold to control the actual flow rates of the hydraulic fluid from the hydraulic pump to the plurality of hydraulic vibrators thereby controlling the actual frequencies of the plurality of hydraulic vibrators, wherein the actual flow rates are continuously updated towards the target flow rates based on the actual flow rates measured by the plurality of flow meters.

4. The paving machine of claim 3, wherein the plurality of flow meters are coupled between the hydraulic manifold and the plurality of hydraulic vibrators.

5. The paving machine of claim 1, wherein the one or more rheometers are vane rheometers.

6. The paving machine of claim 1, wherein the one or more rheometers comprise a plurality of rheometers, wherein the controller is configured to perform a weighted average of the rheological parameters from the plurality of rheometers.

7. The paving machine of claim 1, wherein the controller is configured to control a speed of the paving machine based on the rheological parameters.

8. The paving machine of claim 1, wherein the paving machine comprises one or more cameras, wherein the one or more cameras are configured to generate images of a top surface of the concrete, wherein the controller is configured to receive the images, detect one or more surface voids in the images, and dynamically update at least one of the target frequencies or the target flow rates based on the one or more surface voids detected in the images.

9. The paving machine of claim 1, wherein the paving machine comprises an electric vibrator, a vibrator motor controller, and a current meter, wherein the vibrator motor controller is configured to set the electric vibrator to a fixed voltage and fixed vibrator frequency, wherein the current meter is configured to measure an actual current to the electric vibrator, wherein the controller is configured to dynamically update at least one of the target frequencies or the target flow rates based on the actual current.

10. The paving machine of claim 1, wherein the slipform mold is an inset mold and is configured to form the concrete into a slab, wherein the slipform mold comprises a finishing pan and a pair of side plates, wherein the one or more rheometers are laterally disposed between the pair of side plates.

11. The paving machine of claim 10, wherein the one or more rheometers are longitudinally disposed between the plurality of hydraulic vibrators and the finishing pan.

12. The paving machine of claim 11, wherein the slipform mold comprises a grout box auger, wherein the grout box auger spans between the pair of side plates, wherein the grout box auger is longitudinally disposed between the plurality of hydraulic vibrators and the finishing pan.

13. The paving machine of claim 12, wherein a rotational speed of the grout box auger is adjusted based on at least one of a speed of the paving machine or the rheological parameters.

14. The paving machine of claim 11, wherein the one or more rheometers comprise a plurality of rheometers, wherein the controller is configured to dynamically update at least one of the target frequencies or the target flow rates for the plurality of hydraulic vibrators which are on a left-side and a right-side of the slipform mold based on the rheological parameters from the plurality of rheometers which are disposed on respective of a left-side and a right-side, respectively, of the slipform mold.

15. The paving machine of claim 11, comprising one or more depth sensors, wherein the one or more depth sensors are configured to generate depth maps of the concrete, wherein the controller is configured to receive the depth maps and determine the rheological parameters based on the depth maps in combination with the one or more rheometers.

16. The paving machine of claim 15, wherein the one or more depth sensors are disposed above the plurality of hydraulic vibrators.

17. The paving machine of claim 1, wherein the slipform mold is an offset mold and is configured to form the concrete into one of a curb-and-gutter or a barrier, wherein the slipform mold comprises a hopper and a forming section, wherein the one or more rheometers are disposed in the hopper.

18. The paving machine of claim 1, wherein the paving machine is one of a two-track machine, a three-track machine, or a four-track machine.

19. The paving machine of claim 1, wherein the paving machine is communicatively coupled with a mixer truck, wherein the paving machine is configured to receive the rheological parameters, a placement position, and a placement time from the mixer truck, wherein the controller is configured to dynamically update at least one of the target flow rates or the target frequencies based on the rheological parameters, the placement position, and the placement time.

20. A paving machine comprising:
a slipform mold, wherein the slipform mold is configured to form concrete, the slipform mold comprising:
a plurality of electric vibrators, wherein the plurality of electric vibrators are configured to vibrate in response to receiving electric power; and
one or more rheometers, wherein the one or more rheometers are configured to measure rheological parameters of the concrete;
an electric power source;
a vibrator motor controller, wherein the vibrator motor controller is coupled between the electric power source and the plurality of electric vibrators; and
a controller comprising one or more processors configured, via executable code, to:
cause the vibrator motor controller to control actual current from the electric power source to the plurality of electric vibrators thereby controlling actual frequencies of the plurality of electric vibrators; and
dynamically update at least one of target current to the plurality of electric vibrators or target frequencies of the plurality of electric vibrators based on the rheological parameters.
